(19) United States
(12) Patent Application Publication
(10) Pub. No.: US 2004/0040626 A1
(43) Pub. Date: Mar. 4, 2004

(54) Flux, process for preparation and use thereof

(75) Inventors: Devendra Deo Narayan Singh, Jamshedpur (IN); Tej Bahadur Singh, Jamshedpur (IN); Arun Kumar Dey, Jamshedpur (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 10/393,385

(22) Filed: Mar. 20, 2003

(30) Foreign Application Priority Data
Mar. 28, 2002 (WO) PCT/IN02/00083

(51) Int. Cl. B05D 1/18

(52) U.S. Cl. 148/26; 423/463; 427/433

(57) ABSTRACT

The present invention relates to a novel flux useful for hot dip galvanizing of iron and iron based alloys. The present invention also relates to a process for the preparation of the flux and to the use thereof for hot dip galvanizing of iron an iron based alloys. The present invention also relates to a method for the hot dip galvanizing of iron and iron based alloys using the novel flux.

### FIELD OF THE INVENTION

The present invention relates to a novel flux useful for hot dip galvanizing of iron and iron based alloys. The present invention also relates to a process for the preparation of the flux and to the use thereof for hot dip galvanizing of iron an iron based alloys. The present invention also relates to a method for the hot dip galvanizing of iron and iron based alloys using the novel flux.

### BACKGROUND OF THE INVENTION

Iron and iron based alloys are hot dip galvanized in molten zinc to provide zinc coating on their surface. Since zinc is anodic to, iron and steel, it provides sacrificial protection towards the surface of the latter. For hot dip galvanizing of different type of articles of iron and steels, the following steps are involved:

1. Pickling

2. Rinsing

3. Fluxing

4. Dry and

5. Hot dip galvanizing

Hitherto known processes for fluxing use a mixture of zinc chloride and ammonium chloride in dry fluxing and ammonium chloride in were fluxing. These know processes are, however, associated with a number of drawbacks such as:

a. They are extremely corrosive towards the steel articles,

b. Dross formation is very high,

c. Pollution problems are encountered due to the decomposition of ammonium chloride to form ammonia and hydrochloric acid fumes and

d. Black spots appear due to improper fluxing i.e. uncleaned oxide on the surface.

In the hot dip galvanizing of iron and iron based alloys, oxides are formed on the surface of the iron or iron alloy, thereby resulting in several problems such as formation of black spots, formation of dross and the like. It is therefore important to provide a flux, which overcomes the aforesaid problems associated with the art.

### OBJECTS OF THE INVENTION

The main object of the invention is to provide a process for the preparation of a novel flux useful for hot dip galvanizing of iron and iron based alloys.

Another object of the invention is to provide an improved process for hot dip galvanizing the said flux, which obviates the above-mentioned drawback.

### SUMMARY OF THE INVENTION

Accordingly, the present invention provides a novel flux useful for hot dip galvanizing of metal substrates, said flux comprising a mixture of chlorides of zinc and ammonia.

In one embodiment of the invention, the amount of zinc chloride is in the range of 35 to 55% by weight in the final flux.

In yet another embodiment of the invention, the amount of ammonium chloride is in the range of 65 to 45% by weight in the final flux.

In another embodiment of the invention, the metal substrate comprises articles made of iron and iron based alloys.

The present invention also provides a process for the preparation of a novel flux useful for hot dip galvanizing of metal substrates which comprises:

i. Preparing 5-50% aqueous solution of zinc chloride and heating to a temperature in the range of 80 to 115° C. and 10-50% aqueous solution of ammonium chloride and heating to a temperature in the range of 80 to 115° C.

ii. Stirring the mixture of solutions resulting from step (i) above under constant stirring while maintaining the temperature under constant stirring while maintaining the temperature in the range of 70 to 110° C.

iii. Raising the gravity of the mixed solution by evaporation to effect solidification of the reacted product, cooling the solution to room temperature for separating resultant flux from the unreacted salts.

In one embodiment of the invention, the solutions are mixed for a period of 30 to 150 minutes

In another embodiment of the invention, the chlorides of zinc and ammonia are selected from either laboratory reagent grade or commercial grade chlorides.

In another embodiment of the invention, the chlorides of zinc and ammonium are substantially free from impurities such as iron.

In another embodiment of the invention, the solutions of chlorides of zinc and ammonium are a common solution of both reagents.

In another embodiment of the invention, the solutions of chlorides of zinc and ammonium are prepared separately and then mixed.

The present invention also provides an improved process for hot dip galvanizing a metal substrate using the said novel flux which comprises:

i. Preparing a bath of 15 to 20% aqueous solution of a flux comprising chlorides of zinc and ammonium, raising the temperature of the flux solution in the temperature range of 40 to 110° C.

ii. Dipping the metal substrate to be galvanized in the said bath

iii. Drying the fluxed metal substrate with hot air and

iv. Galvanizing the metal substrate in molten zinc bath.

In one embodiment of the invention, the dipping of the article is done for a period in the range of 30 to 300 seconds.

The present invention also provides a use of a novel flux comprising a mixture of chlorides of zinc and ammonium for the hot dip galvanizing of metal substrates.

In one embodiment of the invention, the amount of zinc chloride is in the range of 35 to 55% by weight in the final flux.

In yet another embodiment of the invention, the amount of ammonium chloride is in the range of 65 to 45% by weight in the final flux.

In another embodiment of the invention, the metal substrate comprises articles made of iron and iron based alloys.

### DETAILED DESCRIPTION OF THE INVENTION

The present invention describes the synthesis and use of the novel flux-(triple salt flux) used in hot dip galvanizing process. This flux of the surface to be galvanized enables it to get rid of oxides of iron present on the surface. These oxides if present on the surface create problems such as black spots on galvanized materials, dross formation, etc. The fluxing is achieved in two ways:

a. Dry fluxing: Where the article to be galvanizing is treated in the solution of flux prior to their immersion in the molten zinc bath ad

b. Wet fluxing: Where the surface to be galvanized is fluxed in situ into the molten zinc bath itself.

In the process of the present invention, a thin coating of iron-zinc-ammonium chloride is formed on the articles to be galvanized when they are dipped in the appropriate concentration of novel flux consisting of triple slat dissolved in the water. The triple salt is prepared by reaction of zinc chloride and ammonium chloride in an appropriate molecular ratio, temperature and time. The triple salt is crystallized, filtered and used as flux at an appropriate concentration.

The process for the preparation of a novel flux useful for hot dip galvanizing of iron and iron based alloys comprises:

i Preparing 5-50% aqueous solution of zinc chloride and heating to a temperature in the range of 80 to 115° C.

i Preparing 10-50% aqueous solution of ammonium chloride and heating to a temperature in the range of 80 to 115° C.

i Mixing the solutions resulting from step (i) and (ii) above under constant stirring while maintaining the temperature under constant stirring while maintaining the temperature in the range of 70 to 110° C. for a period of 30 to 150 minutes.

i Raising the gravity of the mixed solution by evaporation to effect solidification of the reacted product, cooling the solution to room temperature for separating resultant flux from the un-reacted salts.

According to a feature of invention the chloride of zinc and ammonia may be either laboratory reagent grade or commercial grade, but free from impurities such as iron. The present invention also provides an improved process for hot dip galvanizing using the said novel flux which comprises:

i. Preparing a bath of 15 to 20% aqueous solution of the novel flux prepared by the process as described above raising the temperature of the flux solutions in the temperature range of 40 to 110° C.

ii. Dipping the metal substrate to be galvanized in the said bath for a period in the range of 30 to 300 seconds.

iii. Drying the fluxed metal substrate with hot air and

iv. Galvanizing the articles in molten zinc bath by known methods.

By the process of the present invention, galvanizing of iron and Iron based alloys is achieved having reduced iron based alloy dross generation (10 to 50%) galvanized coating of high adherence and least pollution to the atmosphere.

The following examples are given by ways of illustration and should not be construed to limit the scope of the invention:

### Example 1

A solution of zinc chloride containing 200 gms/lit of zinc chloride was prepared and heated to 100° C. Another solution of ammonium chloride having 800 gms/lit was prepared and also heated to 100° C. Both these solutions was mixed in hot conditions under constant stirring. The mixed solution was boiled for 15 minutes and cooled to room temperature. The filtrate was taken and its specific gravity was raised to get the crystals of triple salt. The crystals were analyzed by X-ray diffractometry and the chemical methods. The strong peaks of ZnCl₃NH₄Cl were observed in X-ray diffraction pattern. The chemical analysis exhibited the following results:

| | |
|---|---|
| % Zn | 22.80 |
| % Cl | 60.06 |
| % ZnCl₂ | 46.00 |
| % NH₄Cl | 54.00 |

### Example 2

A solution having 300 gms/lit of zinc chloride and 600 gms/lit of ammonium chloride was prepared and heated to 110° C. This temperature was maintained for 35 minutes. The solution was cooled to room temperature and filtrate was evaporated to raise its specific gravity and then cooled to achieve the crystals of Triple-salts. The crystals were analyzed using X-ray diffraction and chemical methods and results were the same as described in example 1.

### Example 3

A water solution of 20% of the product prepared as in Example 1 was prepared and small mild steel tube specimens (2.5 cm dia 1.0 mm thickness and 15.0 cm length) were treated in this solution for one minute at 80 to 90° C. These coupons were dried and immersed in the bath having molten zinc at 450° C. Following observations were noted:

i. Evolution of white fumes was 50 to 70% less compared to the conventional process;

ii. Adherence of the coating evaluated by bend test passed the stipulated standard.

iii. Copper sulphate dip test; passes 12 dips

### Example 4

A water solution having 40 gms/100 ml of the triple salt as prepared in Example II was heated to 100° C. and tube specimen of dimensions (2.5 cm dia 1.0 mm thickness and 15.0 cm length) were treated in this solution for 1 minute. They were then dried and dipped in galvanizing bath maintained at 450° C. The following observations were noted:

i. The white fumes evolution was less by 50-70% compared to conventional bath;

ii. Adherence of the coating passed the standard tests of adherence.

iii. Copper sulphate dip test: Passed 12 dips

### Example 5

### Corrosion Studies

Mild steel coupons of size 7.5 cm×7.5 cm were immersed in the solution prepared by this invention and also in the solution conventionally prepared, for 6 hours maintaining the temperature of the bath to 70° C. Following results were obtained:

| | Corrosion Rate |
|---|---|
| Flux | mpy |
| Triple salt based flux | 42 |
| As prepared by the present | |
| Invention | |
| Conventional flux | 81 |

These figures indicate that the novel flux based on triple salt are less corrosive.

The main advantage of the present invention are:

i. The present invention reduces the pollution problems compared to conventional fluxes by 50-70%

ii. It is 50% less corrosive than the conventional fluxes. This is expected to reduce dross formation;

iii. Coating is very adherent to the steel surface;

iv. It can be operated at 30 to 40% lower concentrations compared to the conventional fluxes, in the bath leading to saving in space for storage of the chemicals and reduced hazardness due to the handling of diluted solution.

We claim:

1. A novel flux useful for hot dip galvanizing of metal substrates, said flux comprising a mixture of chlorides of zinc and ammonia.

2. A flux as claimed in claim 1 wherein the amount of zinc chloride is in the range of 35 to 55% by weight in the final flux.

3. A flux as claimed in claim 1 wherein the amount of ammonium chloride is in the range of 65 to 45% by weight in the final flux.

4. A flux as claimed in claim 1 wherein the the metal substrate comprises articles made of iron and iron based alloys.

5. A process for the preparation of a novel flux useful for hot dip galvanizing of metal substrates which comprises:
i Preparing 5-50% aqueous solution of zinc chloride and heating to a temperature in the range of 80 to 115° C. and 10-50% aqueous solution of ammonium chloride and heating to a temperature in the range of 80 to 115° C.
ii. Stirring the mixture of solutions resulting from step (i) above under constant stirring while maintaining the temperature under constant stirring while maintaining the temperature in the range of 70 to 110° C.
iii. Raising the gravity of the mixed solution by evaporation to effect solidification of the reacted product, cooling the solution to room temperature for separating resultant flux from the unreacted salts.

6. A process as claimed in claim 5 wherein the solutions are mixed for a period of 30 to 150 minutes.

7. A process as claimed in claim 5 wherein the chlorides of zinc and ammonia are selected from either laboratory reagent grade or commercial grade chlorides.

8. A process as claimed in claim 5 wherein the chlorides of zinc and ammonium are substantially free from impurities such as iron.

9. A process as claimed in claim 5 wherein the solutions of chlorides of zinc and ammonium are a common solution of both reagents.

10. A process as claimed in claim 5 wherein the solutions of chlorides of zinc and ammonium are prepared separately and then mixed.

11. A process for hot dip galvanizing a metal substrate comprising:
i. Preparing a bath of 15 to 20% aqueous solution of a flux comprising chlorides of zinc and ammonium, raising the temperature of the flux solution in the temperature range of 40 to 110° C.
ii. Dipping the metal substrate to be galvanized in the said bath
iii. Drying the fluxed metal substrate with hot air and
iv. Galvanizing the metal substrate in molten zinc bath.

12. A process as claimed in claim 11 wherein the dipping of the article is done for a period in the range of 30 to 300 seconds.

13. A process as claimed in claim 11 wherein the amount of zinc chloride is in the range of 35 to 55% by weight in the final flux.

14. A process as claimed in claim 11 wherein the amount of ammonium chloride is in the range of 65 to 45% by weight in the final flux.

15. A process as claimed in claim 11 wherein the metal substrate comprises articles made of iron and iron based alloys.

16. Use of a novel flux comprising a mixture of chlorides of zinc and ammonium for the hot dip galvanizing of metal substrates.

17. Use as claimed in claim 16 wherein the amount of zinc chloride is in the range of 35 to 55% by weight in the final flux.

18. Use as claimed in claim 16 wherein the amount of ammonium chloride is in the range of 65 to 45% by weight in the final flux.

19. Use as claimed in claim 16 wherein the metal substrate comprises articles made of iron and iron based alloys.
